(19) United States
(12) Patent Application Publication
(10) Pub. No.: US 2026/0327757 A1
(43) Pub. Date: Oct. 22, 2026

(54) RAW MATERIAL ALLOY FOR MAGNETIC REFRIGERATION MATERIAL AND MAGNETIC REFRIGERATION MATERIAL

(71) Applicant: SHIN-ETSU CHEMICAL CO., LTD., Tokyo (JP)

(72) Inventors: Junya FUKUDA, Echizen-shi (JP); Tetsuya KUME, Echizen-shi (JP); Koichi HIROTA, Echizen-shi (JP); Hajime NAKAMURA, Echizen-shi (JP)

(73) Assignee: SHIN-ETSU CHEMICAL CO., LTD., Tokyo (JP)

(21) Appl. No.: 19/491,128

(22) PCT Filed: Mar. 7, 2024
(86) PCT No.: PCT/JP2024/008874

§ 371 Date: Dec. 8, 2025

(30) Foreign Application Priority Data
Jun. 19, 2023 (JP) 2023-099973

(51) Int. Cl. C22C 38/00; C22C 38/02; C22C 38/04; H01F 1/147

(52) U.S. Cl. CPC C22C 38/005; C22C 38/002; C22C 38/02; C22C 38/04; H01F 1/14766; C22C 2202/02

(57) ABSTRACT

A raw material alloy for a magnetic refrigeration material represented by the compositional formula R¹(M¹₁₋ₓA¹ₓ)_{y}. The magnetic refrigeration material contains, a main phase, a La(Fe,Si)₁₃ compound having a NaZn₁₃ type crystal structure, represented by the compositional formula R¹(M¹₁₋ₓA¹ₓ)_{y}, 0.1% by volume or more a subphase containing α rare earth element (R²), and contains no α-Fe, or contains α-Fe and has a proportion of the α-Fe of 0.5% by volume or less. The raw material alloy for a magnetic refrigeration material has a small change in the transition temperature due to the homogenization temperature and absorbs hydrogen to the saturated hydrogen amount under a wide range of hydrogenation conditions to stabilize the transition temperature.

### TECHNICAL FIELD

The present invention relates to a raw material alloy for a magnetic refrigeration material that has a small change in the transition temperature due to the homogenization temperature, a magnetic refrigeration material that absorbs hydrogen to the saturated hydrogen amount under a wide range of hydrogenation conditions to stabilize the transition temperature, and an alloy for a magnetic refrigeration material used for producing the magnetic refrigeration material.

### BACKGROUND ART

As fluorocarbons are ozone-depleting substances and global greenhouse gases, a new refrigeration and air conditioning system using no fluorocarbon is attracting attention for the environmental protection. Refrigerants replacing fluorocarbons are being actively developed, but a new refrigerant that is satisfactory from the standpoint of the capabilities, the cost, and the safety has not yet been into practical use.

As different from the ordinary refrigeration and air conditioning systems, on the other hand, a magnetic refrigeration system using the change in entropy associated with increase of the magnetic field (magnetocaloric effect, ΔS) is receiving attention. Examples of a material having a large absolute value of ΔS include Mn(As₁₋ₓSbₓ) (PTL 1) and La(Fe₁₋ₓSiₓ)₁₃Hz (PTL 2). In particular, the former has an extremely large ΔS of −30 J/kgK, and therefore may be capable of becoming an excellent magnetic refrigeration material. However, the toxicity of As as a component of Mn(As₁₋ₓSbₓ) makes the application thereof substantially difficult. La(Fe₁₋ₓSiₓ)₁₃Hz is the most promising substance since ΔS thereof is as large as ≤25 J/kgK, which is the second largest after Mn(As₁₋ₓSbₓ), and the constitutional elements thereof do not exhibit toxicity and are not rare metals. The change in ΔS is limited to the vicinity of the Curie temperature (T_{c}) of the substance exhibiting the magnetocaloric effect, and thus one kind of the material can operate only at one temperature, failing to provide a refrigeration system that necessarily creates substantially wide temperature differences. Therefore, a method, such as replacing a part of the component with another element, is used for changing the operation temperature.

These substances are necessarily allowed to operate in the vicinity of room temperature (approximately −70 to +70° C.). However, there is a problem that as different from the ordinary magnetic refrigeration having been used as a measure for creating extremely low temperatures that cannot be created through the gas refrigeration, the lattice vibration cannot be ignored at the aforementioned operation temperature, which deteriorates the magnetocaloric effect. An AMR (active magnetic regenerative) cycle utilizing the lattice vibration as a heat storage effect has been developed, which may potentially realize a refrigeration and air conditioning system in the vicinity of room temperature utilizing the magnetocaloric effect.

In the AMR cycle, a magnetic refrigeration material is filled in a state having voids through which a heat medium, such as water, can pass (which may be referred to as a head unit). The heat medium can migrate to the high temperature end and the low temperature end through the voids. In the state where the heat medium exists on the side of the low temperature end, a magnetic field is applied to the head unit with a permanent magnet or the like to lower the entropy of the magnetic refrigeration material, by which the temperature of the magnetic refrigeration material is increased. The heat medium is allowed to migrate from the side of the low temperature end to the side of the high temperature end. At this time, the heat medium receives heat from the magnetic refrigeration material, migrates to the side of the high temperature end, and exhausts heat at the high temperature end through a heat exchanger. Subsequently, the magnetic field of the permanent magnet is removed, so as to increase the entropy of the magnetic refrigeration material and to lower the temperature thereof. The heat medium is allowed to migrate from the side of the high temperature end to the side of the low temperature end. At this time, the heat medium is cooled with the magnetic refrigeration material. The cooled heat medium absorbs heat through a heat exchanger. By repeating the cycle, a temperature difference is created between the high temperature end and the low temperature end, resulting in a refrigeration cycle.

In the AMR cycle, the temperature difference that can be created with a material having a single composition is approximately 2 to 10 K while depending on the material. For creating a large temperature difference that is demanded in applications, such as a refrigerator and an air conditioner, magnetic refrigeration materials having different magnetic transition temperatures (T_{c}) are filled from the side of the high temperature end toward the side of the low temperature end, in order from the material having high T_{c} to the material having low Tₑ (i.e., cascade filling), in which heat exchange is performed between the adjacent magnetic refrigeration materials, and thereby a large temperature difference can be created.

### CITATION LIST

### Patent Literatures

PTL 1: JP 2003-28532 A
PTL 2: JP 2006-89839 A

### SUMMARY OF INVENTION

### Technical Problem

For performing heat exchange among the cascade-filled magnetic refrigeration materials, it is necessary that the operation temperatures of the adjacent magnetic refrigeration materials overlap each other, and as a result of the past investigations, it has been found that for example in the case of La(Fe₁₋ₓSiₓ)₁₃, it is preferred for performing favorable heat exchange that the operation temperature (transition temperature) is controlled with high accuracy since the full widths at half maximum are as narrow as 3 to 5 K.

However, the operation temperature of La(Fe₁₋ₓSiₓ)₁₃ is changed depending on the production condition, such as the heat treatment (homogenization) condition and the hydrogenation condition in producing the material, and therefore is difficult to control with high accuracy. In the homogenization treatment, the change in progress of the homogenization due to the temperature and the time thereof causes change in the transition temperature. While it has been known that the hydrogenation treatment is performed for allowing the transition temperature to rise to room temperature, the change in the transition temperature due to the homogenization is carried over after the hydrogenation. Furthermore, the transition temperature is also changed due to the hydrogenation condition since the hydrogen concentration in the material is changed thereby. The failure of the favorable control of the transition temperature fluctuates the overlap amounts among the materials in building the cascade, falling to perform the favorable heat exchange.

The present invention has been developed in view of the aforementioned circumstances, and an object thereof is to provide an alloy for a magnetic refrigeration material and a magnetic refrigeration material that are capable of controlling the transition temperature with high accuracy against the change in the homogenization temperature and the hydrogenation condition.

### Solution to Problem

As a result of earnest investigations by the present inventors, it has been found that the control of the composition of the raw material alloy to the prescribed region can reduce the change in the transition temperature due to the homogenization temperature, and the homogenization treatment performed on the produced raw material alloy in such a manner that the precipitation amounts of the subphase containing a rare earth element and α-Fe are controlled to the prescribed proportions stabilizes the transition temperature through absorption of hydrogen to the saturated hydrogen amount under a wide range of hydrogenation condition, and thus the present invention has been completed.

Accordingly, the present invention provides the raw material alloys for a magnetic refrigeration material and the magnetic refrigeration materials below.

[1]A raw material alloy for a magnetic refrigeration material represented by the compositional formula R¹(M¹₁₋ₓA¹ₓ)_{y}, in which R¹ represents La, or La and at least one kind of an element selected from the group consisting of a rare earth element other than La, and Zr; M¹ represents Fe, or Fe and at least one kind of an element selected from the group consisting of Co, Mn, Ni, Nb, W, Ta, Cr, Cu, Ag, and Ti; A¹ represents Si, or Si and at least one kind of an element selected from the group consisting of Al, Ga, P, Ge, Sn, and In; and x and y each satisfy 0.09≤x≤0.14 and 12.4≤y<13.0.

[2] The raw material alloy for a magnetic refrigeration material according to the item [1], in which y in the compositional formula satisfies 12.5≤y≤12.9.

[3]A magnetic refrigeration material
containing, as a main phase, a La(Fe,Si)₁₃ compound having a NaZn₁₃ type crystal structure, represented by the compositional formula R¹(M¹₁₋ₓA¹ₓ)_{y}, in which R¹ represents La, or La and at least one kind of an element selected from the group consisting of a rare earth element other than La, and Zr; M¹ represents Fe, or Fe and at least one kind of an element selected from the group consisting of Co, Mn, Ni, Nb, W, Ta, Cr, Cu, Ag, and Ti; A¹ represents Si, or Si and at least one kind of an element selected from the group consisting of Al, Ga, P, Ge, Sn, and In; and x and y each satisfy 0.09≤x≤0.14 and 12.4≤y<13.0,
further containing a subphase containing a rare earth element (R²), in which R² represents La, or La and at least one kind of an element selected from the group consisting of a rare earth element other than La, and Zr,
having a proportion of the subphase containing the rare earth element (R²) of 0.10% by volume or more,
containing no α-Fe, or containing α-Fe and having a proportion of the α-Fe of 0.5% by volume or less.

[4] The magnetic refrigeration material according to the item [3], in which the subphase containing the rare earth element (R²) contains at least one kind of a material selected from the group consisting of R²M²A², R²₅A²₃, R²₆M²₁₁A²₃, and R²₂M²₁₇, R², in which M² represents Fe, or Fe and at least one kind of an element selected from the group consisting of Co, Mn, Ni, Nb, W, Ta, Cr, Cu, Ag, and Ti; and A² represents Si, or Si and at least one kind of an element selected from the group consisting of Al, Ga, P, Ge, Sn, and In.

[5] The magnetic refrigeration material according to the item [3] or [4], in which R¹ contains Ce in an amount of 30% by atom or less.

[6] The magnetic refrigeration material according to any one of the items [3] to [5], in which the subphase containing the rare earth element (R²) contains R²₅A²₃.

[7] The magnetic refrigeration material according to the item [6], in which the proportion of R²₅A²₃ in the subphase containing the rare earth element (R²) is 20% by volume or more.

[8] The magnetic refrigeration material according to any one of the items [3] to [7], in which the proportion of the subphase containing the rare earth element (R²) in the magnetic refrigeration material is 2.00% by volume or less.

[9] The magnetic refrigeration material according to any one of the items [3] to [8], in which the magnetic refrigeration material contains hydrogen in an amount of 1.7% by atom or less.

### Advantageous Effects of Invention

The present invention can provide a raw material alloy for a magnetic refrigeration material that has a small change in the transition temperature due to the homogenization temperature, and a magnetic refrigeration material that absorbs hydrogen to the saturated hydrogen amount under a wide range of hydrogenation conditions to stabilize the transition temperature.

### BRIEF DESCRIPTION OF DRAWINGS

FIG. 1 is a graph plotting the change in Tₚₑₐₖ due to the homogenization treatment.

FIG. 2 is a figure showing the results of the structural observation of the subphase containing the rare earth element (R²) for each homogenization temperature of the magnetic refrigeration material of Comparative Example 1.

FIG. 3 is a figure showing the change of the Si amount in the main phase for each homogenization temperature of the magnetic refrigeration material of Comparative Example 1.

FIG. 4 is a figure showing the content of α-Fe in subjecting the raw material alloys for a magnetic refrigeration material of Examples 1 to 3 and Comparative Examples 1 to 3 to a heat treatment at 1,105° C. for 50 hours.

FIG. 5 is a figure showing the m-T characteristics in subjecting the raw material alloys for a magnetic refrigeration material of Examples 1 to 3 and Comparative Examples 1 to 3 to a heat treatment at 1,105° C. for 50 hours.

FIG. 6 is a figure showing the m-T characteristics in subjecting the magnetic refrigeration materials of Example 4 and Comparative Example 5 to a hydrogenation treatment at 200° C. for 3 hours under a 0.1 MPa hydrogen atmosphere.

FIG. 7 is a figure showing the m-T characteristics in subjecting the magnetic refrigeration materials of Example 4 and Comparative Example 7 to a hydrogenation treatment at 500° C. and 0.1 MPa for 1 hour.

### DESCRIPTION OF EMBODIMENTS

The raw material alloy for a magnetic refrigeration material of the present invention is a raw material alloy for a magnetic refrigeration material represented by the compositional formula R¹(M¹₁₋ₓA¹ₓ)_{y}, in which R¹ represents La, or La and at least one kind of an element selected from the group consisting of a rare earth element other than La, and Zr; M¹ represents Fe, or Fe and at least one kind of an element selected from the group consisting of Co, Mn, Ni, Nb, W, Ta, Cr, Cu, Ag, and Ti; A¹ represents Si, or Si and at least one kind of an element selected from the group consisting of Al, Ga, P, Ge, Sn, and In; and x and y each satisfy 0.09≤x≤0.14 and 12.4≤y<13.0.

In the raw material alloy for a magnetic refrigeration material of the present invention represented by the compositional formula R¹(M¹₁₋ₓA¹ₓ)_{y}, x is 0.09 or more and 0.14 or less, as described above, and is preferably 0.095 or more and 0.105 or less. The smaller x is, the larger the change amount in magnetization due to the phase transition is, but a value of x of less than 0.09 destabilizes R¹(M¹₁₋ₓA¹ₓ)_{y}, making it difficult to perform homogenization. On the other hand, the increase of x lowers ΔS of the magnetic refrigeration material obtained after the homogenization due to the phase transition that approaches the secondary phase transition, and therefore x is 0.14 or less. With the value of x of 0.095 or more, an alloy containing 95% or more of a main phase can be readily obtained through ordinary homogenization, which is, for example, a treatment at 1,100° C. for 50 hours. On the other hand, the smaller x is, the larger ΔS is, and therefore x is preferably 0.105 or less. ΔS herein is the difference in entropy (S) appearing at the phase transition temperature.

In the composition, y is 12.4 or more and less than 13.0, and preferably 12.5 or more and 12.9 or less. In the case where y is less than 12.4, the change in the transition temperature due to the homogenization temperature becomes intense, and a treatment temperature at which the transition temperature is intensely increased occurs. In the case where y is 13.0 or more, on the other hand, the distinct precipitation of α-Fe begins to be confirmed in the resulting magnetic refrigeration material due to the exceedance of the stoichiometric amount thereof. While depending on the condition, for example, y of 13.0 or more may cause several times increase of the precipitation amount of α-Fe. As a result, the magnetization at the transition temperature or higher is increased to decrease the change amount of magnetization due to the transition. Owing to the reason, y is 12.4 or more and less than 13.0, and preferably 12.5 or more and 12.9 or less.

In the raw material alloy for a magnetic refrigeration material of the present invention, R¹ may represent La, or may represent La and at least one kind of an element selected from the group consisting of a rare earth element other than La, and Zr. M¹ may represent Fe, or may represent Fe and at least one kind of an element selected from the group consisting of Co, Mn, Ni, Nb, W, Ta, Cr, Cu, Ag, and Ti. A¹ may represent Si, or may represent Si and at least one kind of an element selected from the group consisting of Al, Ga, P, Ge, Sn, and In.

The proportion of La in R¹ is preferably 50 to 100% by atom, more preferably 65 to 100% by atom, further preferably 70 to 100% by atom, and still further preferably 90 to 100% by atom.

The proportion of Fe in M¹ is preferably 97 to 100% by atom.

The proportion of Si in A¹ is preferably 50 to 100% by atom.

A magnetic refrigeration material containing a main phase and a subphase containing a rare earth element (R²), in which R² represents La, or La and at least one kind of an element selected from the group consisting of a rare earth element other than La, and Zr, can be obtained by subjecting the raw material alloy for a magnetic refrigeration material having the aforementioned composition to a homogenization treatment described later.

The magnetic refrigeration material of the present invention contains, as a main phase, a La(Fe,Si)₁₃ compound having a NaZn₁₃ type crystal structure, represented by the compositional formula R¹(M¹₁₋ₓA¹ₓ)_{y}, in which R¹ represents La, or La and at least one kind of an element selected from the group consisting of a rare earth element other than La, and Zr; M¹ represents Fe, or Fe and at least one kind of an element selected from the group consisting of Co, Mn, Ni, Nb, W, Ta, Cr, Cu, Ag, and Ti; A¹ represents Si, or Si and at least one kind of an element selected from the group consisting of Al, Ga, P, Ge, Sn, and In; and x and y each satisfy 0.09≤x≤0.14 and 12.4≤y<13.0, further contains a subphase containing a rare earth element (R²), in which R² represents La, or La and at least one kind of an element selected from the group consisting of a rare earth element other than La, and Zr, and α-Fe precipitated from the raw material alloy for a magnetic refrigeration material, and has a proportion of the subphase containing the rare earth element (R²) in the raw material alloy for a magnetic refrigeration material of 0.1% by volume or more, and a precipitation amount of α-Fe in the raw material alloy for a magnetic refrigeration material of 0.5% by volume or less.

In the main phase contained in the magnetic refrigeration material of the present invention, R¹ may represent La, or may represent La a part of which is replaced by at least one kind of an element selected from the group consisting of a rare earth element other than La, and Zr. M¹ may represent Fe, or may represent Fe a part of which is replaced by at least one kind of an element selected from the group consisting of Co, Mn, Ni, Nb, W, Ta, Cr, Cu, Ag, and Ti. A¹ may represent Si, or may represent Si a part of which is replaced by at least one kind of an element selected from the group consisting of Al, Ga, P, Ge, Sn, and In.

In the case where R¹ is La a part of which is replaced by at least one kind of an element selected from the group consisting of a rare earth element other than La, and Zr, the transition temperature, the full widths at half maximum, the hysteresis, and the like of the magnetic refrigeration material can be controlled. In the rare earth element, it is particularly preferred that a part of La is replaced by at least one kind of a rare earth element selected from the group consisting of Ce, Nd, and Pr from the standpoint of the control.

Among the above, in the case where a part of La in R¹ is replaced by Ce, 30% by atom or less of the entire R¹ may be replaced thereby; in the case where a part thereof is replaced by Nd, 35% by atom or less of the entire R¹ may be replaced thereby; and in the case where a part thereof is replaced by Pr, 50% by atom or less of the entire R¹ may be replaced thereby. Within the ranges, the increase of the transition temperature due to the magnetic field is decreased, the full width at half maximum is decreased to increase ΔS, and the hysteresis is increased. The effect of increasing ΔS is largest in Ce.

In the case where a part of La is replaced by Zr, 10% by atom or less of the entire R¹ may be replaced thereby. Within the range, the transition temperature can be increased by several K. The lower limits of the replacement ranges are not particularly limited, and may be, for example, 1% by atom of the entire R¹.

For R₂ in the subphase, a part of La may be replaced by at least one kind of an element selected from the group consisting of a rare earth element other than La, and Zr.

The proportion of La in each of R¹ and R² is preferably 50 to 100% by atom, more preferably 65 to 100% by atom, further preferably 70 to 100% by atom, and still further preferably 90 to 100% by atom.

In the case where M¹ is Fe a part of which is replaced by at least one kind of an element selected from the group consisting of Co, Mn, Ni, Nb, W, Ta, Cr, Cu, Ag, and Ti, the transition temperature, as described above, the full widths at half maximum, the hysteresis, and the like of the magnetic refrigeration material can be controlled. Among the above, in the case where a part of Fe is replaced by Mn, 0% by atom or more and 3% by atom or less of the entire M¹ may be replaced thereby. Within the range, the addition thereof can be performed without decomposition of the structure, and the transition temperature can be decreased. The lower limit of the replacement range is not particularly limited, and may be, for example, 1% by atom of the entire M¹.

In the case where the subphase contains M² (in which M² represents Fe, or Fe and at least one kind of an element selected from the group consisting of Co, Mn, Ni, Nb, W, Ta, Cr, Cu, Ag, and Ti), M² in the subphase may also be Fe a part of which is replaced by at least one kind of an element selected from the group consisting of Co, Mn, Ni, Nb, W, Ta, Cr, Cu, Ag, and Ti.

The proportion of Fe in each of M¹ and M² is preferably 97 to 100% by atom.

In the case where A¹ is Si a part of which is replaced by at least one kind of an element selected from the group consisting of Al, Ga, P, Ge, Sn, and In, the transition temperature, the full widths at half maximum, the hysteresis, and the like can be controlled. Among the above, in the case where a part of Si is replaced by Al, 50% by atom or less of the entire A¹ may be replaced thereby. Within the range, the transition temperature is decreased, and the hysteresis can also be decreased. The lower limit of the replacement range is not particularly limited, and may be, for example, 1% by atom of the entire A¹.

In the case where the subphase contains A² (in which A² represents Si, or Si and at least one kind of an element selected from the group consisting of Al, Ga, P, Ge, Sn, and In), A² in the subphase may also be Si a part of which is replaced by at least one kind of an element selected from the group consisting of Al, Ga, P, Ge, Sn, and In.

The proportion of Si in each of A¹ and A² is preferably 50 to 100% by atom.

The magnetic refrigeration material of the present invention can be obtained by subjecting the raw material alloy for a magnetic refrigeration material described above to a homogenization treatment. The magnetic refrigeration material of the present invention has the subphase containing the rare earth element (R²), which facilitates the progress of hydrogenation, enabling absorption of hydrogen to the saturated hydrogen amount under a wide range of hydrogenation conditions. The subphase containing the rare earth element (R²) preferably contains at least one kind of a material selected from R²M²A², R²₅A²₃, R²₆M²₁₁A²₃, and R²₂M²₁₇, R², which is in equilibrium with the main phase, and more preferably contains R²₅A²₃ among these.

The formed amount of the subphase containing the rare earth element (R²) may vary depending not only on the composition of the magnetic refrigeration material but also on the homogenization treatment, and the subphase is contained in a proportion of 0.1% by volume or more, preferably 0.1% by volume or more and 2.0% by volume or less, and more preferably 0.1% by volume or more and 0.5% by volume or less, based on the entire magnetic refrigeration material. Within the range, the absorption to the saturated hydrogen amount under a wide range of hydrogenation conditions can be performed. The mechanism therefor is considered that the subphase containing the rare earth element (R²) contained therein introduces microcracks associated with the volume expansion in hydrogenation, facilitating the progress of the hydrogenation.

In the case where R²₅A²₃ is formed, the proportion thereof is preferably 20% by volume or more of the subphase containing the rare earth element (R²). In the case where the proportion is in the range, the magnetization change due to the transition becomes steep. The mechanism therefor is considered that the distribution of the composition in the main phase becomes more homogeneous. The upper limit value of the content of R²₅A²₃ in the subphase containing the rare earth element (R²) is not particularly limited, and may be, for example, 100% by volume.

The magnetic refrigeration material of the present invention preferably contains no α-Fe. However, there is a case where the magnetic refrigeration material of the present invention contains α-Fe in addition to the main phase and the subphase described above, and in this case, the proportion of α-Fe is preferably 0.5% by volume or less, and more preferably 0.3% by volume or less, based on the entire amount of the magnetic refrigeration material. Within the range, the appropriate homogenization is performed to increase the amount of the main phase, and thereby a large amount of heat generation can be obtained. The lower limit value of the proportion of α-Fe is not particularly limited, and is 0% by volume since α-Fe is preferably contained therein as little as possible.

The compositional analysis and the calculation of the volume fractions of the main phase, the subphase, and α-Fe can be performed with an SEM. Specifically, 20 micrographs obtained with an SEM are binarized based on the difference in contrast by the composition, and the areas of the phases are calculated for each of the micrographs. The area fractions of the phases are calculated for each of the micrographs, and the average values of the area fractions of the phases calculated for the 20 micrographs are designated as the volume fractions of the phases.

The magnetic refrigeration material of the present invention can be used after hydrogenation for increasing the transition temperature. In the case of hydrogenating, hydrogen can be absorbed by the magnetic refrigeration material theoretically in an amount up to 3.0% by atom, and can be absorbed in an amount of approximately 1.7% by atom or less under atmospheric pressure. Assuming that the magnetic refrigeration material is used at room temperature, hydrogenation is generally frequently performed for increasing the transition temperature. At this time, the hydrogen concentration after the hydrogenation is approximately 1.5 to 1.6. Therefore, in the present invention, hydrogen can be absorbed in an amount of 1.7% by atom or less. The magnetic refrigeration material of the present invention exhibits a stable transition temperature through absorption of hydrogen to the saturated hydrogen amount under a wide range of hydrogenation conditions. The lower limit value of the range of the absorption amount of hydrogen is not particularly limited, and may be, for example, 1% by atom.

The production methods of the raw material alloy for a magnetic refrigeration material and the magnetic refrigeration material of the present invention will be described.

The production methods of the raw material alloy for a magnetic refrigeration material and the magnetic refrigeration material of the present invention are for producing the magnetic refrigeration material described above, and may include a melting step of melting raw materials to provide a raw material alloy containing La, Fe, and Si, a homogenization step of subjecting the resulting raw material alloy to a heat treatment to provide the prescribed structure, and a hydrogenation step of performing hydrogen absorption into the alloy for increasing the magnetic transition temperature, depending on necessity.

In the melting step, metals or alloys as raw materials of the elements are weighed to make the composition of the raw material alloy for a magnetic refrigeration material of the present invention described above, and, for example, the raw materials are melted by heating to 1,500° C. through high frequency melting in an Ar atmosphere, and then cooled as rapid as possible at a cooling rate of 300 to 1,000° C./sec, so as to provide an alloy. The alloy can be cast by a strip casting method or a liquid quenching method while not particularly limited. The strip casting method can achieve rapid cooling, facilitating the formation of a fine favorable structure. The use of the liquid quenching method can achieve more rapid cooling, facilitating the formation of a further fine favorable structure. The raw material alloy for a magnetic refrigeration material of the present invention can be obtained in this manner.

In the homogenization step, the raw material alloy for a magnetic refrigeration material obtained in the melting step is subjected to a heat treatment for the homogenization of the structure. The homogenization treatment may be performed, for example, in a temperature range of 1,100° C. or more and 1,300° C. or less, which is not particularly limited since the temperature may vary depending on the structure and the composition of the alloy. In particular, in the case where a part of La is replaced by a rare earth element, the optimum heat treatment temperature in the homogenization treatment varies. For example, in the case where a part of La is replaced by Ce, the temperature tends to vary by approximately −10 to −20° C., and in the case where a part thereof is replaced by Pr or Nd, the temperature tends to vary by approximately +10 to +30° C., as compared to the case of not replacing. In addition, the temperature may vary by several tens of ° C. depending on the amount of Si, the element species replacing a part of Fe element, and the replacement amount thereof. For example, in the case where the amount of Si is small, the optimum heat treatment temperature tends to be decreased since the decomposition temperature is decreased. Therefore, the optimum heat treatment temperature is not limited to the aforementioned ranges. The optimum heat treatment temperature means that the precipitation amount of Fe is minimized, the precipitation amount of the R²₅A²₃ phase is maximized, and the peak value of the dm/dT-T characteristics is maximized, and can be experimentally determined in consideration of these factors. The homogenization time can be appropriately adjusted depending on the state of the alloy obtained in the melting step, and may be, for example, in a range of 1 hour or more and 100 hours or less, and more preferably 25 hours or more and 75 hours or less. Within the range, the amount of the subphase containing a rare earth element (R²), particularly the amount of the R²₅A²₃ phase, and the amount of α-Fe can be controlled to the optimum ranges. The homogenization treatment is preferably performed in an Ar atmosphere for suppressing the deviation from the charged composition due to evaporation of particular elements from the raw material alloy.

In the hydrogenation step, in the case where the magnetic transition temperature of the resulting magnetic refrigeration material is to be increased, the magnetic refrigeration material may be allowed to absorb hydrogen in a hydrogen atmosphere to provide a hydrogenated product. The specific condition is not particularly limited, and the hydrogen atmosphere may be, for example, a condition of 0.1 to 0.25 MPa. The temperature in the hydrogenation may be, for example, 200° C. or more and 500° C. or less. Within the ranges, the saturated hydrogen concentration can be achieved within a relatively short period of time. The treatment time of hydrogenation may be, for example, in a range of 1 hour or more and 100 hours or less, and more preferably 3 hours or more and 30 hours or less. Within the range, the material having the saturated hydrogen amount can be favorably obtained.

### EXAMPLES

### Examples 1 to 3 and Comparative Examples 1 to 3

La metal, Ce metal, Mn metal, Si metal, and electrolytic iron were weight to make the prescribed composition, melted by heating to 1,500° C. under an Ar atmosphere with a high frequency melting furnace, and cooled at a rate of 300 to 1,000° C./sec by the strip casting method, so as to provide an alloy strip having an average thickness of approximately 300 μm. The compositions of the resulting raw material alloys for a magnetic refrigeration material are shown in Table 1. The composition of the alloy was analyzed with a high resolution ICP emission spectroscope (“SPS 3500DD”, trade name, available from Hitachi High-Tech Corporation).

TABLE 1

| | Composition |
|---|---|
| Comparative Example 1 | La_{0.7}Ce_{0.3}(Fe_{0.885}Mn_{0.01}Si_{0.105})_{12.3} |
| Example 1 | La_{0.7}Ce_{0.3}(Fe_{0.885}Mn_{0.01}Si_{0.105})_{12.5} |
| Example 2 | La_{0.7}Ce_{0.3}(Fe_{0.885}Mn_{0.01}Si_{0.105})_{12.7} |
| Example 3 | La_{0.7}Ce_{0.3}(Fe_{0.885}Mn_{0.01}Si_{0.105})_{12.9} |
| Comparative Example 2 | La_{0.7}Ce_{0.3}(Fe_{0.885}Mn_{0.01}Si_{0.105})_{13.0} |
| Comparative Example 3 | La_{0.7}Ce_{0.3}(Fe_{0.885}Mn_{0.01}Si_{0.105})_{13.2} |

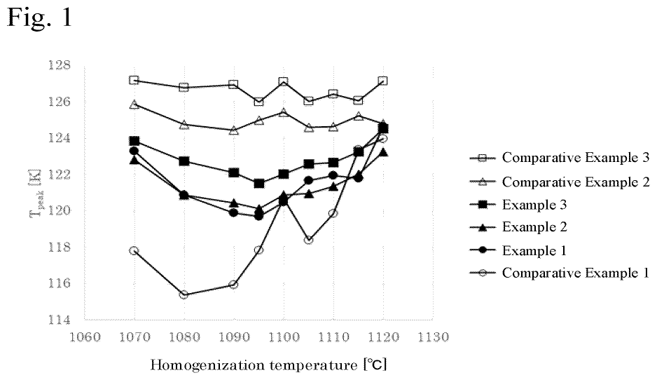

The alloys of Examples 1 to 3 and Comparative Examples 1 to 3 each were subjected to a heat treatment under an Ar atmosphere at a homogenization temperature that was changed to 1,070° C., 1,080° C., 1,090° C., 1,095° C., 1,100° C., 1,105° C., 1,110° C., 1,115° C., and 1,120° C., respectively, for 50 hours. Thereafter, the resulting magnetic refrigeration material was measured for the m-T characteristics with the VSM unit of the portable cryogen-free material characterization platform (“VersaLab”, trade name, available from Quantum Design Inc.). The transition temperature was obtained in such a manner that the m-T characteristics were differentiated with respect to the temperature to provide the dm/dT-T characteristics, in which the temperature of the peak thereof was designated as Tₚₑₐₖ. FIG. 1 shows a graph plotting the change in Tₚₑₐₖ due to the homogenization treatment.

The volume proportions of the subphase containing a rare earth element (R²) and α-Fe contained in the magnetic refrigeration material, the composition of the main phase, and the composition of the subphase were analyzed with a scanning electron microscope (SEM) (“JSM-IT300LV”, trade name, available from JEOL Ltd.). The volume proportion was obtained by subjecting 20 resulting SEM micrographs to the image analysis. The compositions of the main phase and the subphase were analyzed with EDS.

As shown in FIG. 1, in Comparative Example 1 with y=12.3, an anomalous increase in Tₚₑₐₖ is observed at a homogenization temperature of 1,100° C., which makes the control of the transition temperature difficult. On the other hand, in Examples 1 to 3 and Comparative Examples 2 and 3 with y=12.5 or more, an anomalous increase in Tₚₑₐₖ is not observed due to the homogenization temperature, which facilitates the control of the transition temperature.

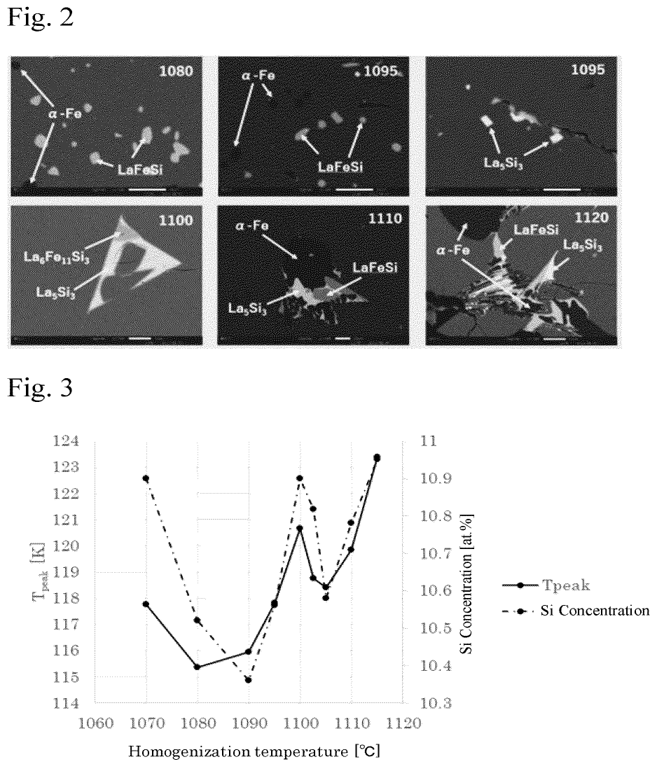

For the magnetic refrigeration material of Comparative Example 1, the result of the structural observation of the subphase containing the rare earth element (R²) for each homogenization temperature is shown in FIG. 2, and the change in the Si amount in the main phase for each homogenization temperature is shown in FIG. 3.

It is understood from the result of the structural observation in FIG. 2 that the structure of the subphase containing the rare earth element (R²) is changed associated with the progress of the homogenization treatment. As shown in FIG. 3, the Si concentration in the main phase is also changed associated therewith. Furthermore, the composition of the subphase containing the rare earth element (R²) suggests that the Mn concentration and the rare earth element concentration in the main phase are also changed. It is considered that the change of the structure of the subphase containing the rare earth element (R²) changes the concentration of the elements other than Fe in M¹ and the concentration of the elements other than Si in A¹ in the main phase, and thereby the transition temperature is changed associated with the progress of the homogenization. With y=12.4 or more, the amount of the subphase containing the rare earth element (R²) is decreased to reduce the concentration change in the main phase due to the change of the subphase associated with the progress of the homogenization, and thereby the change in the transition temperature is relaxed. In FIG. 2, R²M²A² observed was LaFeSi, R²₅A²₃ observed was La₅Si₃, and R²₆M²₁₁A²₃ observed was La₆Fe₁₁Si₃.

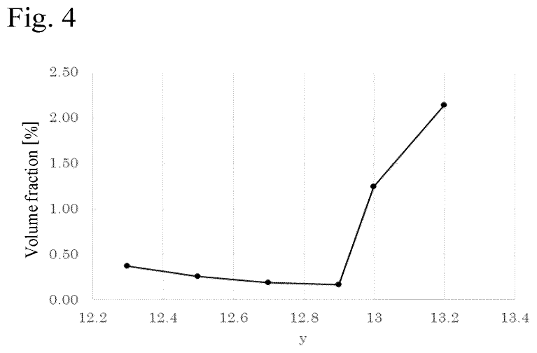

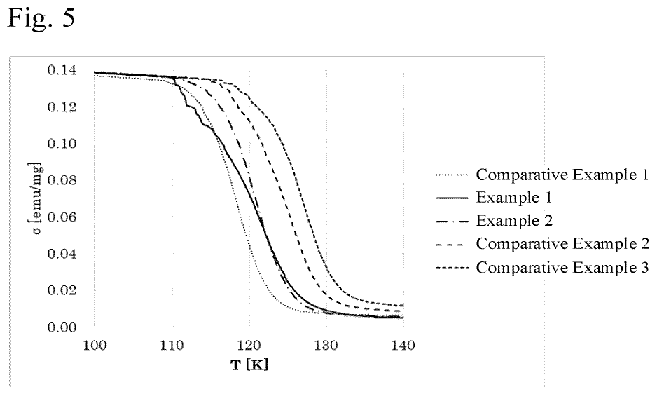

For the raw material alloys for a magnetic refrigeration material of Examples 1 to 3 and Comparative Examples 1 to 3 having been subjected to a heat treatment at 1,105° C. for 50 hours, the content of α-Fe is shown in FIG. 4, and the m-T characteristics are shown in FIG. 5. As shown in FIG. 4, in the raw material alloys of Comparative Examples 2 and 3, α-Fe is not removed but remains even though the homogenization has been optimally performed, and as a result, as shown in FIG. 5, the magnetization of the paramagnetic state at the transition temperature or higher becomes high, which unfavorably decreases the magnetization change due to the transition.

### Examples 4 to 6 and Comparative Examples 4 to 7

In Examples 4 to 6 and Comparative Examples 4 to 6, the raw material alloys for a magnetic refrigeration material of Examples 1 to 3 and Comparative Examples 1 to 3 were subjected to an optimum homogenization treatment at 1,105° C. for 50 hours, so as to provide magnetic refrigeration materials. In Comparative Example 7, the raw material alloy for a magnetic refrigeration material of Example 2 was subjected to a homogenization treatment at 1,080° C. for 50 hours, so as to provide a magnetic refrigeration material.

Table 2 shows the composition of the subphase containing the rare earth element (R²) contained in the magnetic refrigeration material of Example 4. Table 3 shows, for Examples 4 to 6 and Comparative Examples 4 to 7, the volume proportions of the subphase containing the rare earth element (R²) and α-Fe phase, and the proportion of the R²₅A²₃ phase occupied in the subphase containing the rare earth element (R²)

TABLE 2

| | La | Ce | Fe | Mn | Si |
|---|---|---|---|---|---|
| | (% by atom) | (% by atom) | (% by atom) | (% by atom) | (% by atom) |
| R²M²A² | 22.1 | 10.8 | 34.0 | 0.5 | 32.5 |
| R²₅A²₃ | 42.6 | 19.4 | 3.0 | 0.6 | 34.4 |
| R²₆M²₁₁A²₃ | 17.1 | 12.6 | 57.8 | 0.8 | 11.7 |
| R² | 70.5 | 17.9 | 8.1 | 0.2 | 3.4 |
| R²₂M²₁₇ | 3.0 | 8.0 | 77.3 | 1.1 | 10.7 |

TABLE 3

| | | | | Proportion of R²₅A²₃ phase in |
|---|---|---|---|---|
| | | Subphase containing R² | α-Fe | subphase containing R² |
| | y | (% by volume) | (% by volume) | (% by volume) |
| Comparative | 12.3 | 1.47 | 0.37 | 27 |
| Example 4 | | | | |
| Example 4 | 12.5 | 0.80 | 0.26 | 31 |
| Example 5 | 12.7 | 0.43 | 0.18 | 23 |
| Example 6 | 12.9 | 0.10 | 0.16 | 25 |
| Comparative | 13.0 | 0.03 | 1.24 | 20 |
| Example 5 | | | | |
| Comparative | 13.2 | 0.01 | 2.14 | 32 |
| Example 6 | | | | |
| Comparative | 12.7 | 0.01 | 3.46 | 29 |
| Example 7 | | | | |

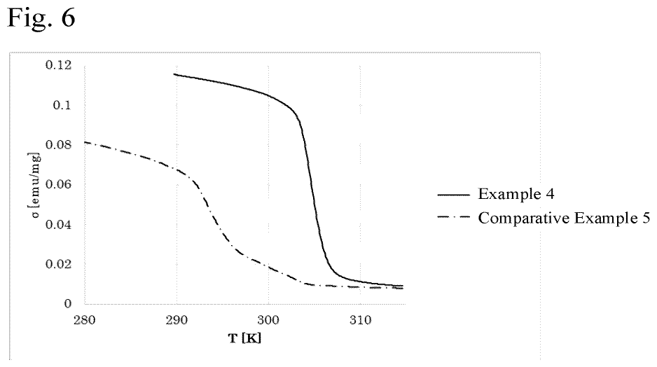

FIG. 6 shows the m-T characteristics in subjecting the magnetic refrigeration materials of Example 4 and Comparative Example 5 to a hydrogenation treatment at 200° C. for 3 hours under a 0.1 MPa hydrogen atmosphere. In Example 4, steep m-T characteristics are obtained since the subphase containing the rare earth element (R²) that exists necessarily and sufficiently facilitates the rapid progress of hydrogenation, resulting in the hydrogen absorption to the saturated hydrogen amount. In Comparative Example 5 (y=13.0), on the other hand, α-Fe is precipitated due to the small amount of the rare earth element (R²), and the subphase containing the rare earth element (R²) is short. The shortage of the subphase containing the rare earth element (R²) inhibits the sufficient progress of hydrogenation, showing m-T characteristics indicating broad and multistep transition, which make it difficult to control the transition temperature difficult. The mechanism therefor is considered that the subphase containing the rare earth element (R²) contained therein in the certain amount or more introduces microcracks associated with the volume expansion in hydrogen absorption, facilitating the progress of the hydrogenation, and consequently the single steep transition appears.

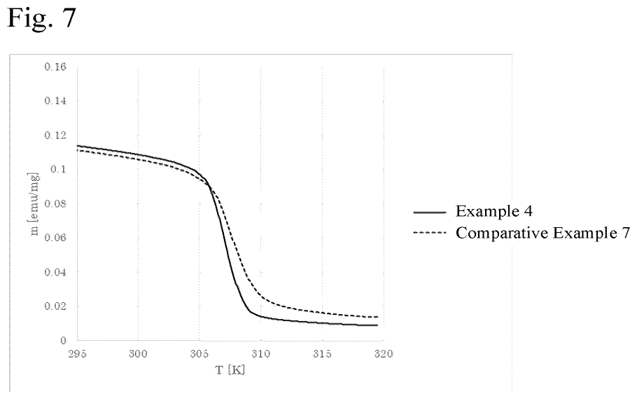

FIG. 7 shows the m-T characteristics in subjecting the magnetic refrigeration materials of Example 4 and Comparative Example 7 to a hydrogenation treatment at 500° C. and 0.1 MPa for 1 hour. In Comparative Example 7, the large precipitation amount of α-Fe increases the magnetization of the paramagnetic state, and thus the magnetization change in using as a magnetic refrigeration material is decreased, which unfavorably decrease the amount of heat that can be extracted.

1. A raw material alloy for a magnetic refrigeration material represented by the compositional formula R¹(M¹₁₋ₓA¹ₓ)_{y}, wherein
R¹ represents La, or La and at least one kind of an element selected from the group consisting of a rare earth element other than La, and Zr;
M¹ represents Fe, or Fe and at least one kind of an element selected from the group consisting of Co, Mn, Ni, Nb, W, Ta, Cr, Cu, Ag, and Ti;
A¹ represents Si, or Si and at least one kind of an element selected from the group consisting of Al, Ga, P, Ge, Sn, and In; and
x and y each satisfy 0.09≤x≤0.14 and 12.4≤y<13.0.

2. The raw material alloy for a magnetic refrigeration material according to claim 1, wherein y in the compositional formula satisfies 12.5≤y≤12.9.

3. A magnetic refrigeration material, comprising,
a La(Fe,Si)₁₃ compound having a NaZn₁₃ type crystal structure, represented by the compositional formula R¹(M¹₁₋ₓA¹ₓ)_{y},
wherein R¹ represents La, or La and at least one kind of an element selected from the group consisting of a rare earth element other than La, and Zr;
M¹ represents Fe, or Fe and at least one kind of an element selected from the group consisting of Co, Mn, Ni, Nb, W, Ta, Cr, Cu, Ag, and Ti;
A¹ represents Si, or Si and at least one kind of an element selected from the group consisting of Al, Ga, P, Ge, Sn, and In; and
x and y each satisfy 0.09≤x≤0.14 and 12.4≤y<13.0, and
a subphase containing a rare earth element (R²), in which R² represents La, or La and at least one kind of an element selected from the group consisting of a rare earth element other than La, and Zr,
wherein the magnetic refrigeration material
has a proportion of the subphase containing the rare earth element (R²) of 0.1% by volume or more, and
has a proportion of α-Fe of 0.5% by volume or less, including 0%, each based on a total volume of the magnetic refrigeration material.

4. The magnetic refrigeration material according to claim 3, wherein the subphase containing the rare earth element (R²) contains at least one kind of a material selected from the group consisting of R²M²A², R²₅A²₃, R²₆M²₁₁A²₃, and R²₂M²₁₇, R², in which M² represents Fe, or Fe and at least one kind of an element selected from the group consisting of Co, Mn, Ni, Nb, W, Ta, Cr, Cu, Ag, and Ti; and A² represents Si, or Si and at least one kind of an element selected from the group consisting of Al, Ga, P, Ge, Sn, and In.

5. The magnetic refrigeration material according to claim 3, wherein R¹ contains Ce in an amount of 30% by atom or less, based on a total number of atoms in the compositional formula R¹(M¹₁₋ₓA¹ₓ)_{y}.

6. The magnetic refrigeration material according to claim 3, wherein the subphase containing the rare earth element (R²) contains R²₅A²₃.

7. The magnetic refrigeration material according to claim 6, wherein a proportion of R²₅A²₃ in the subphase containing the rare earth element (R²) is 20% by volume or more, based on a total volume of the magnetic refrigeration material.

8. The magnetic refrigeration material according claim 3, wherein the proportion of the subphase containing the rare earth element (R²) in the magnetic refrigeration material is 2.00% by volume or less, based on a total volume of the magnetic refrigeration material.

9. The magnetic refrigeration material according to claim 3, wherein the magnetic refrigeration material contains hydrogen in an amount of 1.7% by atom or less, based on a total number of atoms in the magnetic refrigeration material.
